(19) United States
(12) Patent Application Publication
(10) Pub. No.: US 2019/0235574 A1
(43) Pub. Date: Aug. 1, 2019

(54) Virtual Cutouts Between Panels of a Display

(71) Applicant: Motorola Mobility LLC, Chicago, IL (US)

(72) Inventors: William Raymond Groves, Naperville, IL (US); Yongho Lim, Kildeer, IL (US)

(73) Assignee: Motorola Mobility LLC, Chicago, IL (US)

(21) Appl. No.: 15/886,415

(22) Filed: Feb. 1, 2018

(51) Int. Cl. G06F 1/16; B32B 3/02

(52) U.S. Cl. CPC G06F 1/1643; H04M 1/72522; G06F 1/1626; B32B 3/02

(57) ABSTRACT

Various embodiments provide a virtual cutout between panels of a display device. Aspects of one or more implementations provide electronic display circuitry disposed on a substrate that enables a display device to render content on the display. Various implementations include a virtual cutout region between the top panel and the bottom panel of the display device that is devoid of electronic of electronic display circuitry and enables access to functionality other than content-rendering display functionality.

### BACKGROUND

Next-generation computing devices have a constant pressure to evolve features without increasing costs. One such example pertains to an active display area of a computing device. Users oftentimes desire more room dedicated to rendering content without affecting an overall size of the corresponding display device. In other words, the users desire more rendering capability in a same-sized display device. However, various factors can impose restrictions on how large of an area in the display device can be used to render content, as well as affect the overall cost of providing such a display device to the user. For example, some features necessitate that the display device includes a setback region to ensure the display device performs reliably. However, the setback region occupies valuable space without providing the ability to render content in that region. Accordingly, providing a larger active area in a same-sized display can be difficult to design and/or manufacture.

### BRIEF DESCRIPTION OF THE DRAWINGS

Embodiments for virtual cutout regions in a display are described with reference to the following Figures. The same numbers may be used throughout to reference like features and components that are shown in the Figures:

FIG. 1 illustrates an example operating environment in accordance with one or more implementations;

FIG. 2 illustrates an example computing device in accordance with one or more implementations;

FIG. 3 illustrates example views of a physical cutout in a display in accordance with one or more implementations;

FIG. 4 illustrates example views of a virtual cutout in accordance with one or more implementations;

FIG. 5 illustrates an example patterned mask with designated virtual cutout regions in accordance with one or more implementations;

FIG. 6 illustrates an example of forming a pattern mask on a layer of a multilayer display in accordance with one or more implementations;

FIG. 7 illustrates an example of using a pattern mask to generate electronic display circuitry in accordance with one or more implementations;

FIGS. 8a and 8b illustrate an example comparison of active display areas of a same-sized display in accordance with one or more implementations;

FIG. 9 illustrates an example of performing post-processing operations on a display in accordance with one or more implementations;

FIG. 10 is a flow diagram that illustrates operations of generating a virtual cutout in accordance with one or more implementations;

FIG. 11 illustrates various components of an example device that can implement various embodiments.

### DETAILED DESCRIPTION

### Overview

Various embodiments provide a virtual cutout in a dual panel display. Aspects of the dual panel display include at least one active partition between the dual panels, where the active partition includes electronic display circuitry disposed on a substrate. When activated, the active partition can be used to render content. Alternately or additionally, the dual panel display includes a virtual cutout within the structure of the dual panel display. Various implementations interpose the virtual cutout between the dual panels of the dual panel display, where the virtual cutout is devoid of electronic display circuitry and provides, in at least some embodiments, visibility through the dual panel display. Some implementations physically locate interactive components in regions associated with the virtual cutout to enable access to the interactive components without using a physical cutout.

While features and concepts for virtual cutouts in a display device using pattern masking can be implemented in any number of different devices, systems, environments, and/or configurations, embodiments for virtual cutouts using pattern masking are described in the context of the following example devices, systems, and methods.

### Example Operating Environment

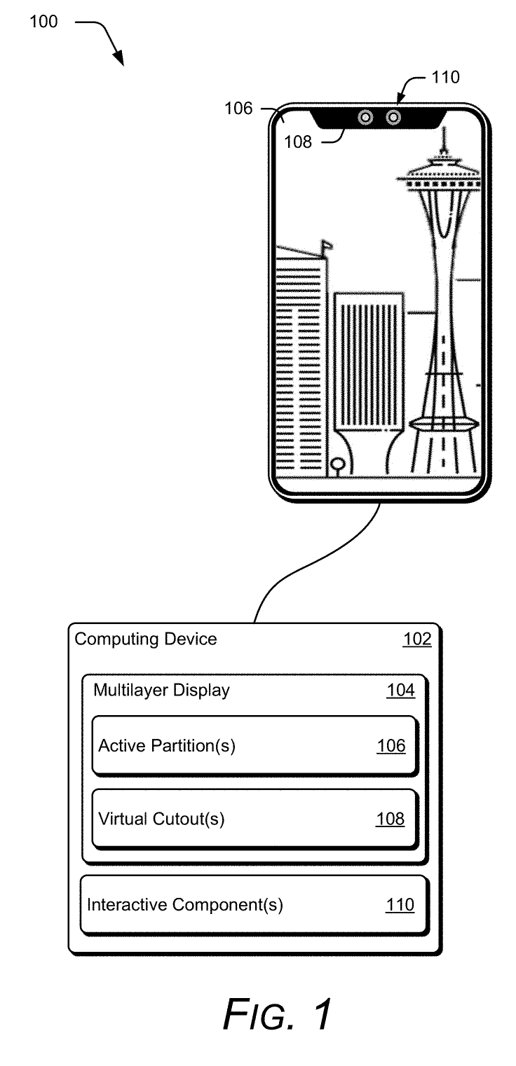

FIG. 1 illustrates example environment 100 according to one or more implementations. Environment 100 includes computing device 102 in the form of a mobile communication device. Here, computing device includes multilayer display 104 to provide a way to render visual content and/or receive touch input from a user.

Multilayer display 104 generally represents a display device that uses multiple different layers of composition to generate an electronic device capable of displaying images. In some implementations, multilayer display represents a dual panel display device that includes a top panel, a bottom panel, and electronic display circuitry disposed on a substrate and interposed between the top panel and the bottom panel. The multilayer display uses the electronic display circuitry, which resides in-between the top panel and bottom panel, to render content. Alternately or additionally, a multilayer display can include various combinations of organic and nonorganic layers to generate the electronic display circuitry (e.g., substrate layer(s), photoresist layer(s), transistor device layer(s), insulation layer(s), sealant layer(s), etc.). As one skilled in the art will appreciated, careful selection of how different materials are layered, where the different layers are electronically coupled, and where the different layers are electronically insulated from one another generates regions within multilayer display 104 that have electronic display circuitry that can be activated by computing device 102 to render content. For example, careful selection of the layer ordering, points of electronic coupling, and/or points of electronic isolation can generate electronic pixel components that, when activated, render a digital image and, at the same time, provide one or more virtual cutouts as described below. Multilayer display 104 can be any suitable type of display such as, by way of example and not limitation, an organic light-emitting diode (OLED) display and/or a Liquid Crystal Display (LCD).

Multilayer display 104 includes active partition(s) 106 and virtual cutout(s) 108. Active partitions 106 represent regions of multilayer display 104 that are capable of electronically displaying content, while virtual cutouts 108 represent regions of multilayer display 104 that provide unobstructed viewing through multilayer display 104. For example, some implementations of active partitions 106 include pixel components generated by electronically coupling and/or insulating various layers included in multilayer display 104. Conversely, virtual cutouts 108 are vacant of any pixel components, thus generating a window of visibility through multilayer display 104. In other words, virtual cutouts 108 are part of the physical structure of multilayer display 104, but are devoid of electronic display circuitry in order to provide visibility through the display and/or access to functionality other than content-rendering display functionality as further described herein. A virtual cutout can include any type of pattern and/or geometry, including a notch, such as an angular, v-shaped, and/or u-shaped notch. Various implementations generate virtual cutouts 108, and/or active partitions 106, in the structure of multilayer display 104 by using a pattern masking process as further described herein.

In environment 100, active partitions 106 of multilayer display 104 follow a generally rectangular shape with the exclusion of, in this example, a trapezoidal shape near the top, where the trapezoidal shape corresponds to virtual cutouts 108 of multilayer display 104. However, active partitions and virtual cutouts can be configured in any other suitable shape can be used without departing from the scope of the claimed subject matter. For example, this example demonstrates a singular and contiguous active partition, and a singular and contiguous virtual cutout, but other implementations can include multiple active partitions and/or multiple virtual cutouts that are contiguous, separated, or any combination thereof. As one example, a virtual cutout can reside in a middle of multilayer display where an active partition surrounds the virtual cutout on all sides by an active partition. Accordingly, using pattern masking to generate virtual cutouts provides the flexibility to place virtual cutouts and/or active partition at any suitable location.

Computing device 102 also includes interactive component(s) 110 in the form of a dual camera that includes two camera lenses. Here, the camera lenses are physically located in a region corresponding to virtual cutouts 108. In turn, this positioning provides the camera lenses with visibility through multilayer display 104. However, computing device 102 can physically locate any other type of component in a region corresponding to a virtual cutout, such as a scanner (e.g., fingerprint, eye, facial, etc.), an audible output device, a microphone, a haptic sensor, a haptic feedback component, and so forth. Here, interactive components 110 visibly occupy regions of the multilayer display that could otherwise be used to display content. Since virtual cutouts 108 provide a window through multilayer display 104, the placement of virtual cutouts 108 corresponds to the placement of interactive components 110 to provide access and/or visibility into the interactive components.

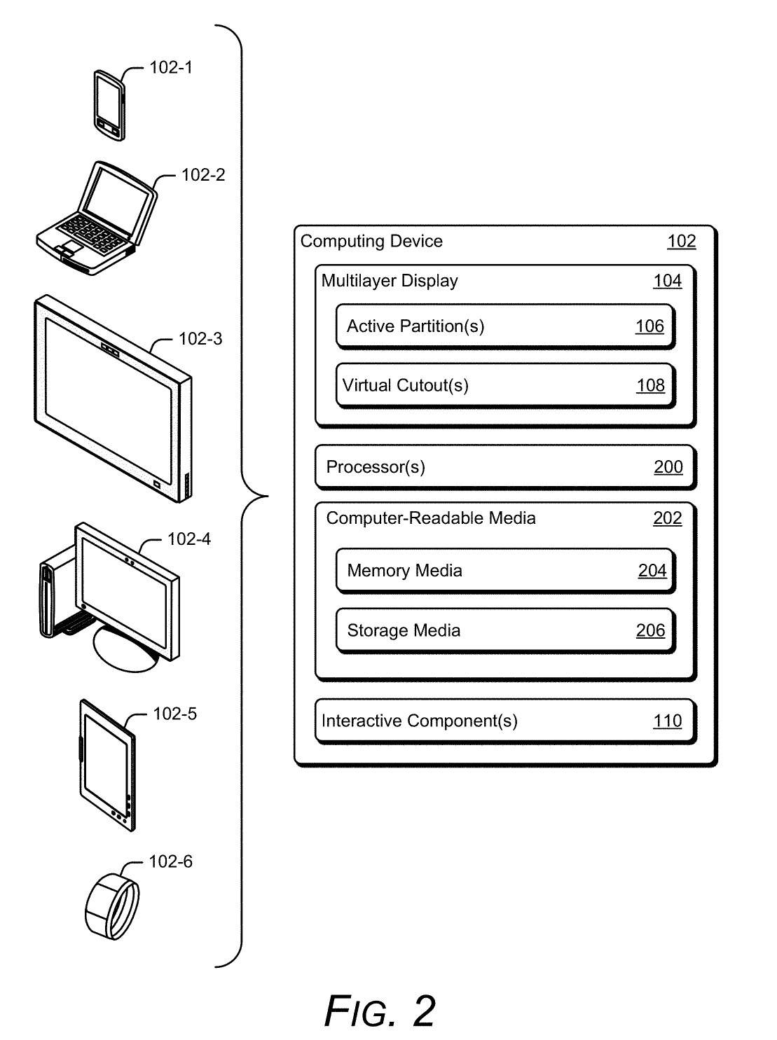

FIG. 2 illustrates an expanded view of computing device 102 of FIG. 1 as being implemented by various non-limiting example devices including: smartphone 102-1, laptop 102-2, smart television 102-3, desktop computer 102-4, tablet 102-5, and smart watch 102-6. Accordingly, computing device 102 is representative of any suitable device that incorporates virtual cutouts in a display device of a computing device. Computing device 102 includes multilayer display 104 of FIG. 1 that additionally has active partitions 106 and virtual cutouts 108 to generate virtual cutouts as further described herein. In various implementations, active partitions 106 and/or virtual cutouts 108 are part of the structure of multilayer display 104 by way of pattern masking techniques as further described herein.

Computing device 102 also includes processor(s) 200 and computer-readable media 202, which includes memory media 204 and storage media 206. Applications and/or an operating system (not shown) embodied as computer-readable instructions on computer-readable media 202 are executable by processor(s) 200 to provide some, or all, of the functionalities described herein. For example, various embodiments can access an operating system module, which provides high-level access to underlying hardware functionality by obscuring implementation details from a calling program, such as protocol messaging, register configuration, memory access, and so forth. In one or more implementations, applications and/or operating systems work in conjunction with one another to drive the display of content on multilayer display 104. Computing device 102 also includes interactive components 110 to provide an interactive user experience, example of which are provided herein. Various embodiments physically locate interactive components 110 at locations corresponding to virtual cutouts 108.

Having described an example operating environment in which various implementations can be utilized, consider now a discussion of pattern masks used to generate virtual cutouts in a layered display device in accordance with one or more implementations.

### Pattern Masks Used to Generate Virtual Cutouts in a Layered Display

One of the challenges in evolving computing devices pertains to making the devices more affordable, evolving functionality included within the device, and maintaining a same or reduced device size relative to previous devices. For instance, some users desire a next generation computing device to have larger active display region relative to previous devices without increasing the physical size of the display device. However, reconciling both of these demands can pose challenges. As an example, some computing devices visibly display interactive components that appropriate regions of the display that could otherwise be used to render content. In turn, this reduces how much of the display can be allocated to active partitions that render content. Accordingly, evolving the display functionality of a next-generation device oftentimes has a need to balance how much of the display can be allocated to rendering content, and how much of the display can be allocated to interactive components, such as fingerprint pads, cameras and the like.

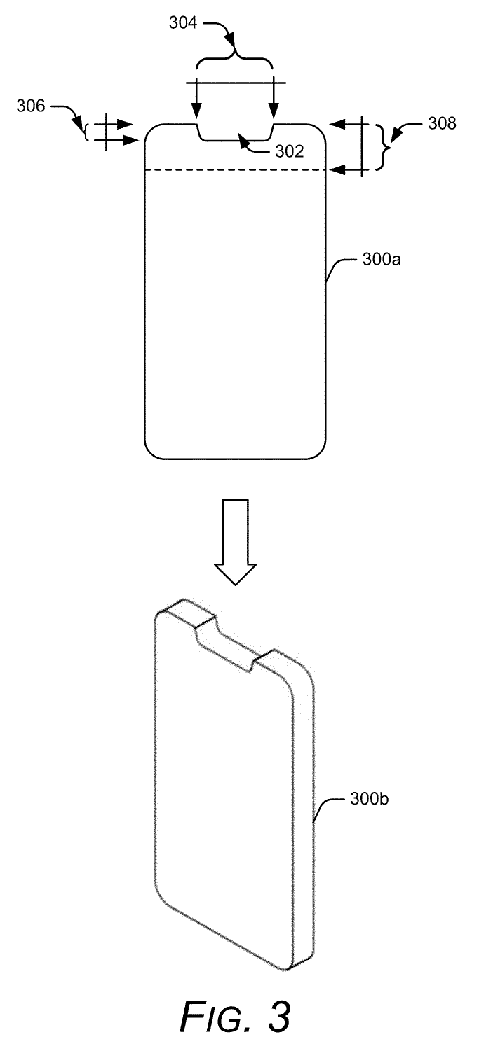

To demonstrate, consider FIG. 3 that illustrates an example of a multilayer display device with a physical cutout used to accommodate interactive components. In the upper portion of FIG. 3, display 300a depicts a front view the multilayer display device, while display 300b depicts a rotated 3-dimensional (3D) view of the same display device. Display 300a generally has rectangular shape, with the exception of a generally trapezoidal cutout 302 on the top-most edge of the display. Here, the term “generally” is used to account for variations and/or deviations from a perfectly rectangular or trapezoidal shape, such as rounded corners and the trapezoidal cutout. As can be seen, trapezoidal cutout 302 has a long-side length 304, a short-side length opposite the long-side which is slightly shorter, and a height 306 that represent any arbitrary length and/or and height of a shape.

Determining the length and height of a corresponding cutout can be based upon any suitable factor, such as a predetermined number and/or type of interactive components designated to be visibly accessible through the display. As illustrated in both display 300a and display 300b, the cutout creates an absence of structure and/or absence of substance in the multilayer display. Accordingly, trapezoidal cutout 302 has removed portions of structure from display 300a to accommodate and expose interactive components. In other words, the top panel, bottom panel, and/or internal structure of the multilayer display have been physically cut in the shape of trapezoidal cutout 302 to make room for the interactive components. In turn, the interactive components occupy the region of the physical cutout in the absence of structure corresponding to trapezoidal cutout 302.

While cutting out a portion of a display device provides a way to accommodate interactive components, the physical cutouts have drawbacks. For instance, manufacturing a physical cutout in the multilayer display increases the costs of manufacturing the multilayer display. To generate the modified rectangular shape, a first process uses a cutting tool with a particular size and/or diameter to cut the rectangular shape. In order to achieve the finer shaping of the physical cutout, a second process uses a second cutting tool with finer granularity relative to the first cutting tool to physically cut the notch out of the rectangular shape. In other words, the process uses a two-step process with two or more separate cutting tools to generate the physical cutout. These separate processes and/or the separate cutting tools increase the manufacturing costs and complexities of generating a display with a physical cutout, which is then passed on to the consumer in the form of a higher-priced computing device.

Another downside to a physical cutout corresponds to unavoidable setbacks that occupy valuable display regions. When a display includes a physical cutout, setbacks around the cutout are used to ensure proper internal sealing between the physical cutout and active partitions in order to reduce the probability of the active regions failing. In FIG. 3, display 300a includes setback 308 as an example setback used in conjunction with trapezoidal cutout 302. Some implementations base the size and shape of setback 308 on a size and/or shape of the corresponding cutout, such as length 304 and/or height 306 of trapezoidal cutout 302. In FIG. 3, setback 308 represents a region of display 300a that is unable to render content. The dashed line corresponds to a boundary line of setback 308, where the region above the line associated is incapable of rendering content as by lacking the electronic components to do so, and the region below the dotted line is capable of rendering content as by including the electronic components to do so. Accordingly, the setback region occupies valuable space of the display.

Various embodiments provide a virtual cutout in a multi-layered, dual panel display. Aspects of the dual panel display include at least one active partition between the dual panels, where the active partition includes electronic display circuitry disposed on a substrate. When activated, the active partition can be used to render content. Alternately or additionally, the dual panel display includes a virtual cutout within the structure of the dual panel display without making physical cuts to the top panel and/or the bottom panel.

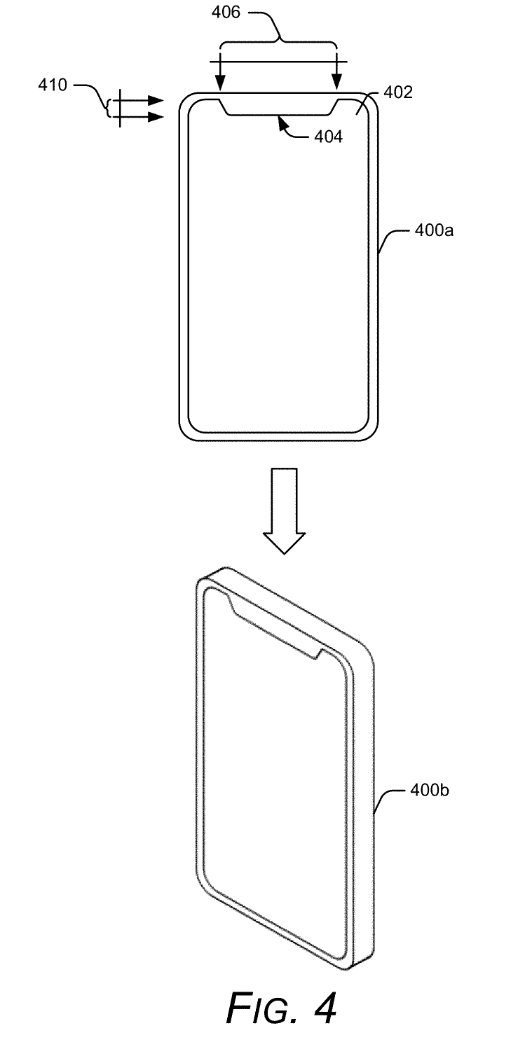

To demonstrate, now consider FIG. 4 that illustrates an example of a multilayer display that incorporates a virtual cutout and/or window to accommodate interactive components using a pattern masking technique in accordance with one or more implementations. In the upper portion of FIG. 4, display 400a depicts a front view the multilayer display, while display 400b depicts a rotated 3D view of the same display. For this discussion, assume the rectangular shape of display 400a has the same overall width and height dimensions of the generally rectangular shape of display 300a. Display 400a includes active partition 402 that is a region capable of rendering content. Active partition 402 has a generally rectangular shape, with the exception of virtual cutout 404 at the top edge of the rectangle. In this example, virtual cutout 404 has a generally trapezoidal shape similar to the cutout region of display 300a of FIG. 3 and is generally positioned at, or near, an edge of the display. The phrase “generally positioned” is used here to indicate that the cutout does not have to reside at an exact edge of the display, but can reside at a position that is closer to one particular edge relative to other edges. Instead of physically cutting a trapezoidal shape out of the multilayer display, a patterning process during fabrication generates virtual cutout 404 to provide a window through the multilayer display. Accordingly, the regions of the top panel and/or bottom panel of display 400a corresponding to virtual cutout 404 have substance and/or structure, rather than being void of structure. In other words, virtual cutout 404 provides a window through two panels of the multilayer display without a physical cutout to the panels in that region. Instead, virtual cutout 404 extends through the top panel and the bottom panel to enable visibility through the multilayer display, where virtual cutout 404 is devoid of the electronic display circuitry included in active partition 402. An advantage to the unified nature of the active partition and the virtual cutout within display 400a is that it allows for smaller setback regions, larger active display regions, and larger regions for interactive components relative to display 300a of FIG. 3. Some implementations alternately or additionally seal the perimeter of a virtual cutout region (e.g., virtual cutout 404) internally and/or between the panels of the multilayer display as a way to improve, control, and/or reduce radio frequency (RF) leakage in the region. Relative to a setback region, the perimeter sealing process is less invasive, and occupies less space.

To illustrate, first consider the shape of virtual cutout 404, which is a generally trapezoidal shape having an arbitrary length 406 and arbitrary height 408. In some implementations, the length and height of virtual cutout 404 can be larger than the length and height used for trapezoidal cutout 302 of FIG. 3 since there is no physical cutout in the display panels. The unified nature of virtual cutout 404 and active partition 402 supports smaller setback region relative to setback 308. In turn, the smaller setback region can be leveraged to increase the size of regions capable of rendering content. To demonstrate, active partition 402 expands up and around virtual cutout 404 to border and surround the virtual cutout on three sides: the corresponding bottom, left, and right sides of the virtual cutout, thus providing more viewing opportunities in display 400a relative to display 300a.

Virtual cutouts also provide more space for interactive components, relative to physical cutouts, without negatively affecting the size of active partitions, since virtual cutouts reduce the size of a setback region. In FIG. 4, virtual cutout 404 has an expanded size relative to trapezoidal cutout 302, and the resultant display uses the larger space to expose more interactive components. Thus, relative to display 300a, display 400a provides larger active partitions to render content with, and larger regions for exposing interactive components. Further, by using pattern masking to generate virtual cutout 404, the manufacturing process eliminates any secondary process associated with cutting out a smaller cutout shape, and subsequently reduces the cost of generating display 400a.

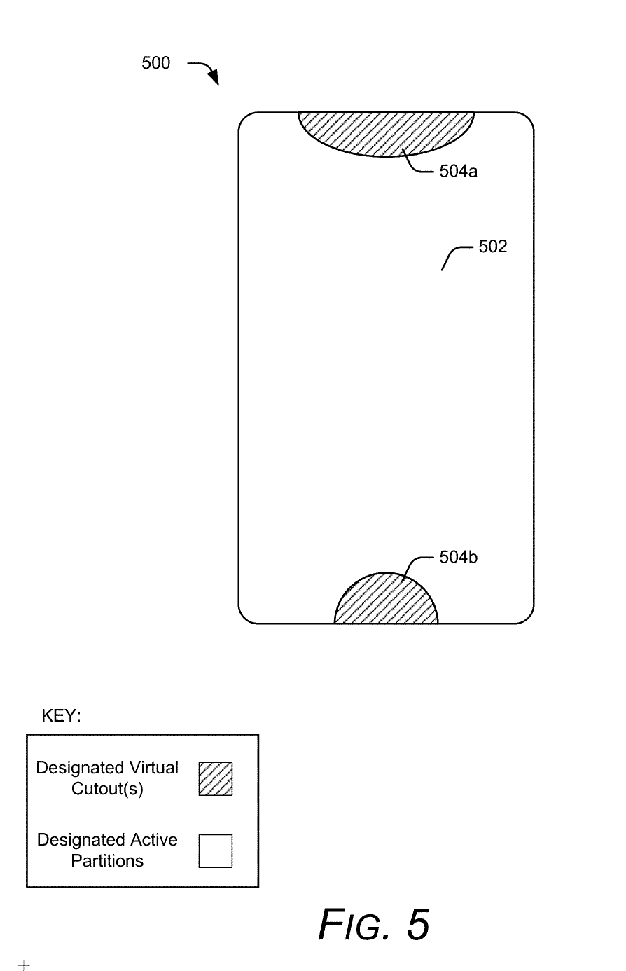

In the example described with respect to FIG. 4, the multilayer display included a virtual cutout with a size and shape in a location on the display similar to that used for the physical cutout of FIG. 3. However, pattern masking can be used to generate any other suitable combination of virtual cutouts. To illustrate, consider FIG. 5 that demonstrates an example pattern mask in accordance with one or more embodiments. As one skilled in the art will appreciate, the discussion here has been simplified, and is not intended to describe all technical aspects of generating a multilayer display.

FIG. 5 includes mask 500 that designates the active partitions of a resultant multilayer display, and the virtual cutouts of the multilayer display. In some implementations, mask 500 can be used to physically mask and/or block various processing activities, examples of which are provided herein. The overall shape of mask 500 is generally rectangular, with rounded corners to anticipate and/or resemble a multilayer display with the same shape. However, mask 500 has partitioned its corresponding shape into active regions and cutout regions. For example, mask 500 includes an active region 502 used to designate active partitions in the multilayer display, and two cutout regions: cutout region 504a and cutout region 504b.

In mask 500, active region 502 designates areas of a corresponding multilayer display capable of rendering content, and cutout region 504a and cutout region 504b designate areas in the corresponding multilayer display that are transparent and/or provide a window through the multiple layers and/or panels of the multilayer display. In this example, active region 502 is generally rectangular, with the exception of two modifications to the rectangle. The first modification, cutout region 504a, has the shape of half an ellipse, and is located at the upper short-end of the rectangle. The second modification, cutout region 504b, is located at an opposite edge of cutout region 504a, and it positioned at the lower short-end of the rectangle. While this example illustrates each of the cutouts at an edge of the corresponding multilayer display, a virtual cutout can be located in any suitable region, such as in the middle of active region 502 where all sides of the cutout are surrounded by an active partition. Some implementations base the shapes and sizes of virtual cutouts on an anticipated interactive component. For example, the shape of cutout region 504b corresponds to a fingerprint scanner incorporated into the multilayer display, while the shape of cutout region 504a corresponds to a dual camera being incorporated into the multilayer display. However, the shape and/or size can be based on any other suitable type of interactive component, such as an audio output module, an eye scanner, etc.

In various implementations, a fabrication process uses mask 500 to generate a multilayer display. As one skilled in the art will appreciated, a multilayer display can include multiple layers of different materials that are used to form electronic display circuitry. For instance, a semiconductor fabrication process can form a first layer of material used in electronic display circuitry, and then alter the first layer to form a predetermined pattern corresponding to data lines, groves, isolation buffers, and so forth. After completing alterations to the first layer, the semiconductor fabrication process then applies a second layer of material on top of the first layer, and modifies the second layer to form data lines, grooves, isolation buffers, etc. This process generally repeats for the different layers to create connections and/or isolation points between the different layers at decisive locations to form electronic display circuitry. Accordingly, the fabrication process can include applying and/or removing temporary substances, developing and/or ash-ing off substances, exposing various regions and/or layers to lasers and/or light, and so forth, to form connections and/or isolation points at the decisive locations. As one skilled in the art will appreciate, the respective alterations to each layer can vary from layer to layer.

To illustrate, consider a semiconductor material with light-emitting properties, such as indium gallium nitride. By placing a layer of indium gallium nitride on top of a transparent substrate layer, and making particular traces, patterns, connections, and/or isolations between the layers, the process can generate a light-emitting diode (LED). Selectively activating the LED with the proper amount of voltage to the corresponding leads causes the LED to emit light. In a similar manner, a multilayer display device can layer, connect, isolate, and/or trace several different compositions of semiconductor material, substrates, barrier materials, and so forth to form components capable of rendering content (e.g., LEDs, pixel components, subpixel components, etc.). Various implementations apply mask 500 to various layers as a way to form virtual cutout regions and/or active partitions in a multilayer display as further described herein.

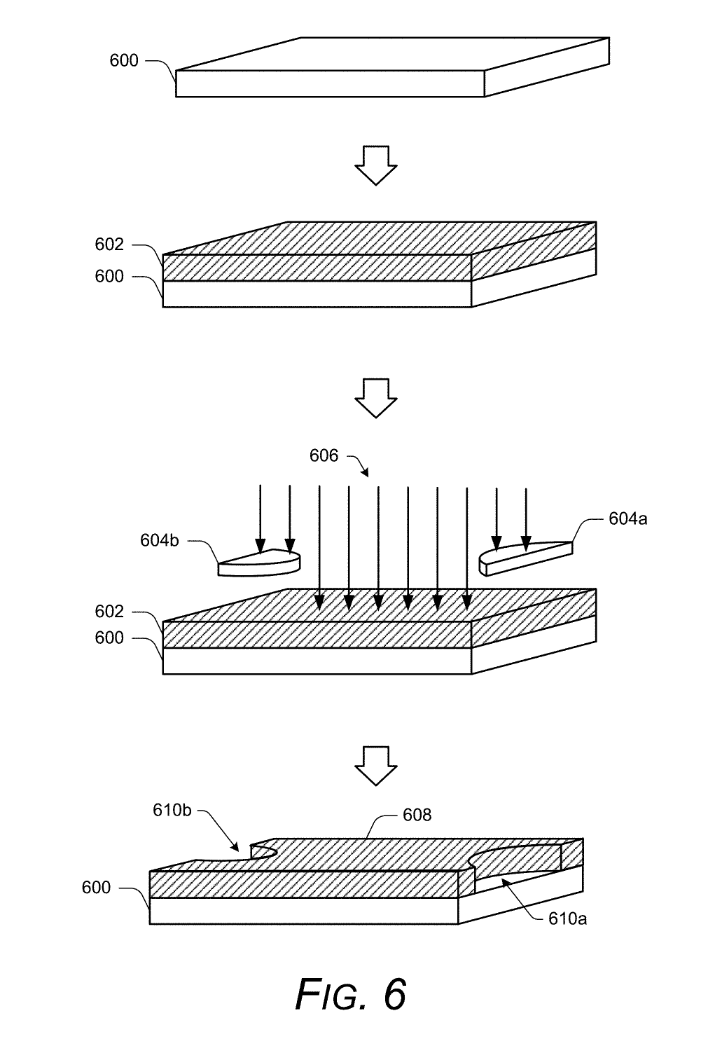

To demonstrate, consider FIG. 6 that illustrates an example of generating a physical mask on another material, such as applying mask 500 on one or more layers used in the construction of a multilayered display. In FIG. 6, layer 600 represents any suitable layer of material used to form the electronic display circuitry of the multilayered device. Applying a patterned mask to the top of layer exposes distinct portions of the layer to processing actions that alter the layer as further described herein, and insulate other distinct regions of the layer from the alterations.

Various implementations initially coat layer 600 with a second material that is used to form a mask layer, such as a light-sensitive material. In FIG. 6, the mask layer is formed using photoresist 602, which initially covers layer 600 in its entirety. Photoresist 602 represents any suitable type of mask layer material, such as a positive photoresist material or a negative photoresist material. Positive photoresist materials denote light-sensitive materials that dissolve during a development process when exposed to a laser/light. Conversely, negative photoresist materials signify light-sensitive materials that maintain structure during a development process when exposed to the laser/light. Thus, various implementations form a pattern mask, such as mask 500 of FIG. 5, out of photoresist materials by selectively exposing some regions of the photoresist materials to light, and selectively insulating other regions.

To form mask 500 out of photoresist 602, some implementations use a light pattern mask to selectively expose and protect regions of photoresist 602 to/from light. Generally, a light pattern mask represents a light mask that administers which regions of photoresist 602 are exposed to light, and which regions of photoresist 602 are blocked from the light. In FIG. 6, the light pattern mask includes two light-blocking regions: light block region 604a and light block region 604b. Light block region 604a corresponds to cutout region 504a of Figurer 5, while light block region 604b corresponds to cutout region 504b. Some implementations apply the light pattern mask to glass plate using light-allowing and/or light-blocking material, and pass light through the glass plate, reduction lenses, and so forth. Accordingly light block regions 604a and 604b can be implemented on a glass plate using light-blocking material in corresponding shapes. In turn, exposing the light pattern mask to light results in exposing photoresist 602 to light and shadow. This is generally illustrated with light arrows 606.

In this example, photoresist 602 represents a negative photoresist material. Because of this, the regions of photoresist 602 exposed to light maintain structure during the developing process, and the regions of photoresist 602 blocked from light dissolve during the developing process. This generates patterned mask layer 608 that represents a modified version of photoresist 602 to form mask 500 out of the photoresist material. Here the portions of patterned mask layer 608 that have maintained structure define active partitions, and the portions of patterned mask layer 608 that have dissolved define virtual cutouts. As can be seen, virtual cutout region 610a corresponds to cutout region 504a of FIG. 5, and virtual cutout region 610b corresponds to cutout region 504b.

After forming patterned mask layer 608 on layer 600, the combined structure of layer 600 and patterned mask layer 608 can be exposed to other types of processing actions, such as a processing action that dissolves layer 600 to generate a virtual cutout. Here, the photoresist material acts as an insulator. Accordingly, any processing actions applied to the exposed regions of layer 600 corresponding to virtual cutout regions 610a and 610b would modify layer 600 in those regions. Conversely, any processing actions applied to the regions insulated by the photoresist material would be blocked, leaving the insulated regions protected from the processing actions. This provides the semiconductor fabrication process with a way to generate virtual cutout regions without modifying the top and/or bottom panels, and a way to increase the display capabilities of the corresponding multilayered display.

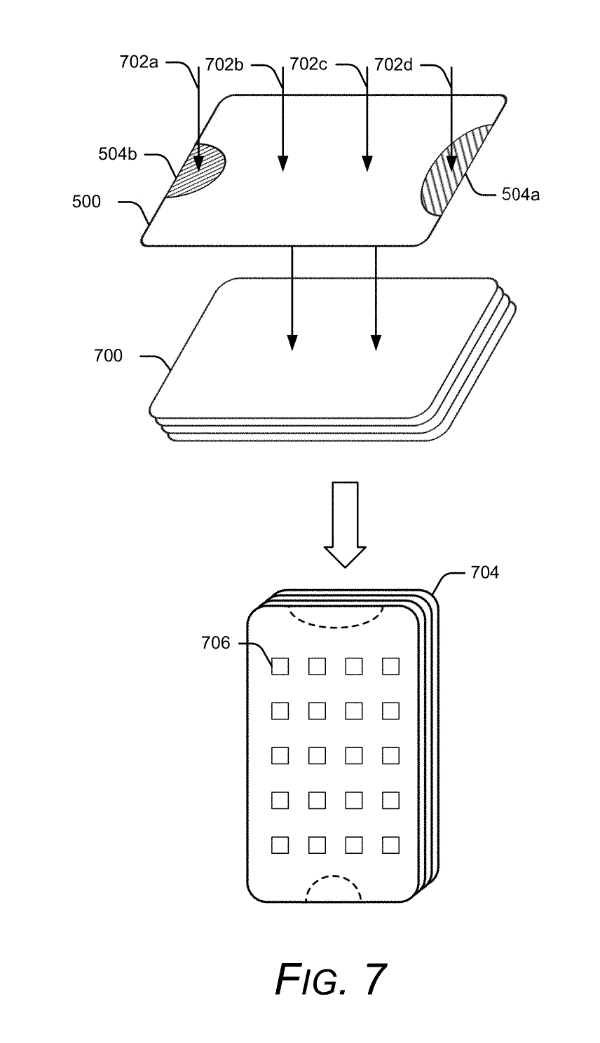

While FIG. 6 described an example in which as a process action dissolves the corresponding structure of a layer to generate a virtual cutout, other processing actions, in combination with a patterned mask, can alternately or additionally be used to generate electronic display circuitry. To demonstrate, consider now FIG. 7 that generally illustrates an example of generating a multilayer display using a patterned mask. FIG. 7 includes mask 500 of FIG. 5 that has virtual cutout region 504a and virtual cutout region 504b. In FIG. 7, virtual cutout regions 504a and 504b block processing actions, while the other portions of mask 500 allow the processing actions.

FIG. 7 includes layered structure 700 that represents a layered component used to build a multilayer display at the pre-processing stage. For simplicity's sake, layered structure 700 is illustrated here as a rectangular block with four adjacent layers. However, it is to be appreciated that building the multilayered display can encompass a multistep process in which layers are individually added and altered before another layer is added to layered structure 700. Layered structure can include any combination of layers and materials, such can substrate material layers, light-emitting semiconductor material layers, insulation material layers, barrier layers, bond layers, and so forth.

As each layer of layered structure 700 is applied, various implementations apply patterned masks to block or allow processing actions in order to etch data paths, build insulating layers, and so forth, in the designated regions of the material. These processing actions are generally represented in FIG. 7 as: processing action 702a, processing action 702b, processing action 702c, and processing action 702d. Processing actions 702a-702d represent any combination of types and/or number of actions that can be used to generate a multilayer display that includes circuitry that resides between two panels, where the circuitry can be activated to render content.

Since the processing actions of FIG. 7 are directed towards building electronic display circuitry, the applied patterned mask (e.g., mask 500), blocks the processing actions in virtual cutout regions 504a and 504b, and allows the processing actions in all other regions. Layered structure 704 in the lower portion of FIG. 7 represents a post-processing version of layered structure 700 that is capable of displaying content. Here, layered structure 704 includes electronic display circuitry 706 in the form of a pixel component, but any other type of circuitry can be created out of the layered structure without departing from the scope of the claimed subject matter. Thus, layered structure 704 includes electronic display circuity in regions as defined by mask 500 as active partitions, and is devoid of any electronic display circuitry in regions designated as virtual cutout regions. As those skilled in the art will appreciate, generating electronic display circuitry using layered structures can be found in various patent publications, such as, by way of example and not of limitation, U.S. Pat. No. 9,806,100, U.S. Pat. No. 8,502,211, and U.S. Pat. No. 9,806,272.

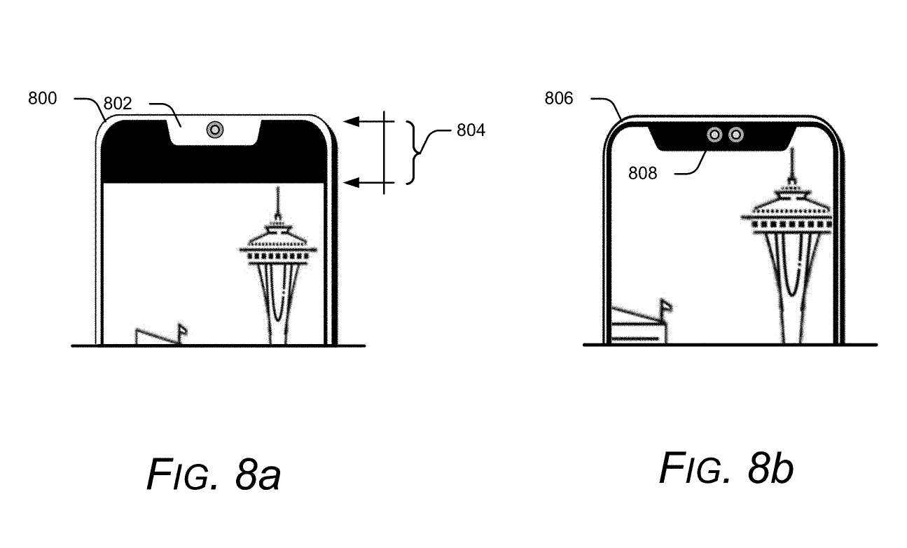

An advantage to using pattern masking to generate a multilayer display is the ability to expand an active display region of the multilayer display without increasing the size of the multilayer display. Pattern masking allows displays to reclaim setback regions previous designated as inactive, and convert the setback regions into active display regions. An example, FIGS. 8a and 8b illustrate two displays to demonstrate differences between an active display region of a device using physical notch device relative to an active display region for a display using a virtual cutout. Mobile communication device 800 of FIG. 8a includes physical notch 802. Subsequently, because the display includes a physical notch, mobile communication device 800 includes a setback region 804 that is incapable of displaying content. Conversely, mobile communication device 806 of FIG. 8b includes a virtual cutout 808 generated through the use of various pattern-masking techniques as further described herein. In turn, the multilayer display of mobile communication device 806 has a larger active display region-to-display-size ratio relative to the multilayer display of mobile communication device 800, since the multilayer display of mobile communication device 806 has reclaimed portions of setback region 804 as active partitions that can render content.

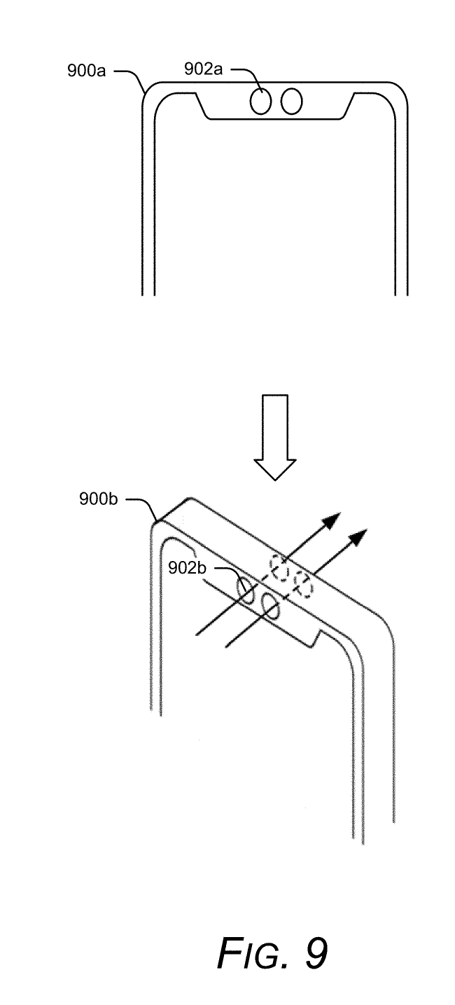

Some implementations apply less expensive post-processing to virtual cutouts and/or virtual cutouts as well. FIG. 9 depicts an example of a post-processing device that generates an aperture through the multilayer display in a virtual cutout region. In the upper portion of FIG. 9, display 900a depicts a front view the multilayer display device, while display 900b depicts a rotated 3-dimensional (3D) view of the same display device. Here, display 900a includes two portholes and/or apertures 902a that extend through the back of display 900a. This is further illustrated via apertures 902b that include through arrows to indicate that the apertures extend through the structure of display 900b. These apertures can be used for any suitable purpose, such as an audio port that projects through the virtual cutout via an aperture. Further, by sealing the panels of the multilayer display around perimeter and/or circumference of a virtual cutout, negative effects of adding an aperture through the region (e.g., RF noise and/or leakage) can be mitigated. The perimeter can be sealed in any suitable manner.

The generation of virtual cutouts through pattern masks provides an efficient way to increase active display regions of a display device without increasing an overall display size by reclaiming and/or repurposing setback regions for active display partitions as further described herein. This not only increases an active display region size, but additionally reduces manufacturing costs of the display device by eliminating a second, and costly, cutting process that is used to generate physical notches and/or cutouts. In other words, pattern masking can be used to generate virtual cutouts within the display device, rather than requiring the display device to be physically cut to generate a physical notch. The pattern masking process additionally provides visibility into interactive components with the flexibility to place virtual cutouts at any desired location.

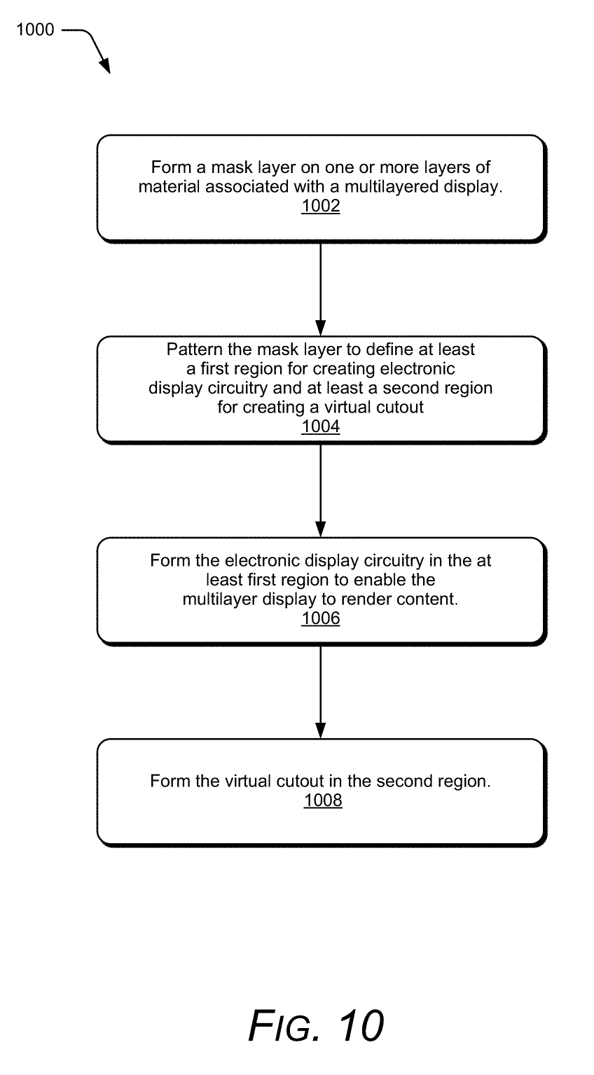

FIG. 10 is a flow diagram that illustrates an example method 1000 that employs pattern masking to generate virtual cutouts between the panels of a multilayer display in accordance with one or more embodiments. Any suitable type of device can be used to implement the flow diagram, such any combination of semiconductor fabrication devices (e.g., etching devices, photolithography and/or masking devices, reactor devices, chemical processing devices, etc.). The semiconductor fabrication devices can be implemented using software, firmware, hardware (e.g., fixed logic circuitry), manual processing, or any combination thereof to implement example method 1000. Some operations of the example method may be described in the general context of executable instructions stored on computer-readable storage memory that is local and/or remote to a computer processing system utilized by a semiconductor fabrication device, and implementations can include software applications, programs, functions, and the like. Alternately or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. While method 1000 illustrates steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

Block 1002 forms a mask layer on one or more layers of material associated with a multilayered device. For example, the mask layer can coat an entire top surface of a layer. Alternately or additionally, forming the mask layer can be an iterative process, where a fabrication process applies a mask layer to each layer at different points in time during a fabrication process. The layers of material can include any suitable combination of materials in any suitable order. The layers associated with the multilayered device can include substrate material layers, semiconductor material layers, insulation material layers, and so forth. The mask layer can include any type of material that acts as an insulator to underlying regions of the layer which are coated with the mask layer, such as a photoresist material.

In response to forming the mask layer, block 1004 patterns the mask layer to define at least a first region on the one or more layers for creating electronic display circuitry, and at least a second region on the one or more layers for creating a virtual cutout. Some implementations pattern the mask layer utilizing a light pattern mask that exposes portions of the mask layer to light, and blocks other portions of the mask layer from the light as further described herein. Alternately or additionally, the mask layer is developed to remove portions of the mask layer effective to form the desired pattern.

Responsive to patterning the mask layer, block 1006 forms the electronic display circuitry based on the patterned mask. This can include performing additional processing acts to exposed areas of the one or more layers. Alternately or additionally, the patterned mask layer can be removed after performing the additional processing acts, and a new layer can be added to the one or more layers. Accordingly, forming the electronic display circuitry can be an iterative and/or multi-step process that utilizes multiple applications of the patterned mask. When properly activated, the electronic display circuitry enables the multilayer display to render content.

Block 1008 forms the virtual cutout in the at least second region by forming regions devoid of the electronic display circuitry. In a multilayer display, the virtual cutouts can reside between a top panel and a bottom panel of the multilayer display to enable visibility through the multilayer display. For instance, some implementations include a glass panel as a top panel overlaying the virtual cutout to enable visibility through the multilayer display.

Having described generating virtual cutouts using pattern masking techniques, consider now an example computing device that can implement the embodiments described above.

Example Device

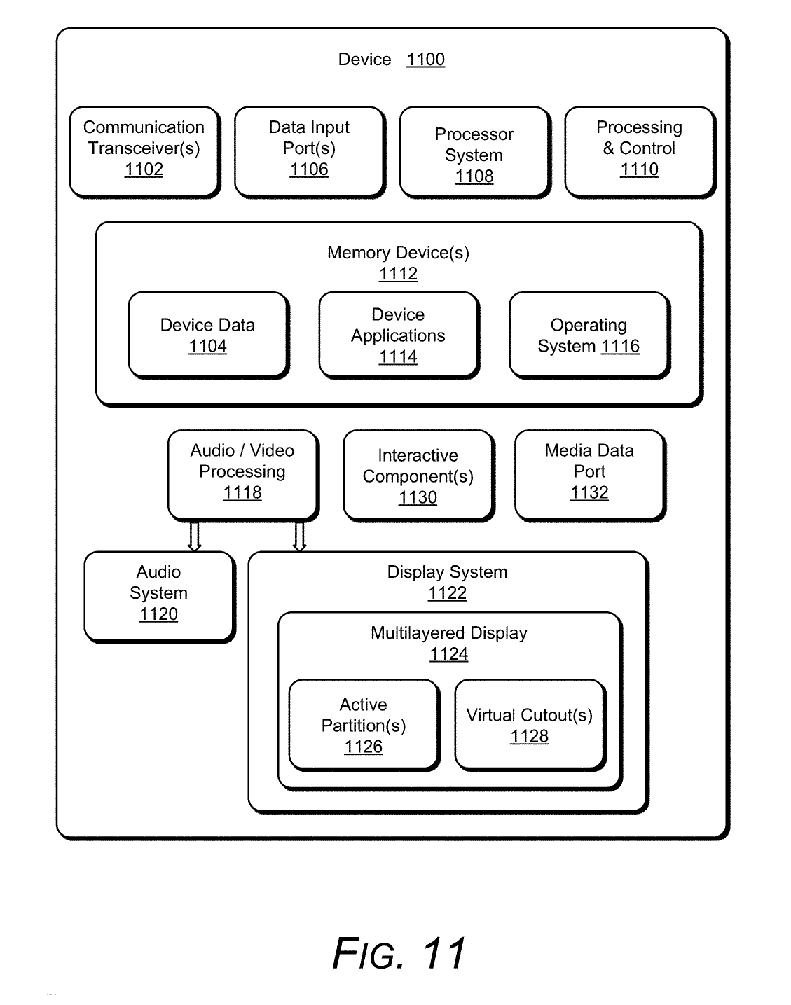

FIG. 11 illustrates various components of an example device 1100 in which virtual cutouts via pattern masking can be implemented. The example device 1100 can be any suitable type of computing device, such as any type of mobile communication device, phone, tablet, computing, communication, entertainment, gaming, media playback, and/or other type of device. For example, computing device 102 shown in FIG. 1 may be implemented as the example device 1100.

The device 1100 includes communication transceivers 1102 that enable wired and/or wireless communication of device data 1104 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include Universal Serial Bus (USB) ports, coaxial cable ports, and other serial or parallel connectors (including internal connectors) for flash memory, DVDs, CDs, and the like. These data input ports may be used to couple the device to any type of components, peripherals, or accessories such as microphones, cameras, and/or modular attachments.

The device 1100 includes a processing system 1108 of one or more processors (e.g., any of microprocessors, controllers, and the like) and/or a processor and memory system implemented as a system-on-chip (SoC) that processes computer-executable instructions. In some embodiments, processing system 1108 includes a low power contextual processor and an application processor as further described herein. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that is implemented in connection with processing and control circuits 1110, which generally represents any of the aforementioned combinations. The device 1100 may further include any type of a system bus or other data and command transfer system that couples the various components within the device. A system bus can include any one or combination of different bus structures and architectures, as well as control and data lines.

The device 1100 also includes computer-readable storage memory or memory devices 1112 that enable data storage, such as data storage devices that can be accessed by a computing device, and that provide persistent storage of data and executable instructions (e.g., software applications, programs, functions, and the like). Examples of the computer-readable storage memory or memory devices 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on

The device 1100 also includes an audio and/or video processing system 1118 that generates audio data for an audio system 1120 and/or generates display data for a display system 1122.

In some embodiments, display system 1122 includes a multilayer display 1124, such as a dual panel LCD, a dual panel OLED, and so forth. Some implementations of the multilayer display 1124 include active partition(s) 1126 and virtual cutout(s) 1128, where the multilayer display can include any combination of active partitions and virtual cutouts. For instance, the multilayer display 1124 can include a single contiguous active partition with multiple virtual cutouts, multiple active partitions with a single contiguous virtual cutout, or multiple active partitions with multiple virtual cutouts.

Active partitions 1126 represent regions of the multilayer display 1124 that include electronic display circuitry capable of rendering content. In some implementations, the electronic display circuitry is interposed between two panels of multilayer display 1124.

Virtual cutouts 1128 represent regions of the multilayer display 1124 that are devoid of the electronic display circuitry between a top panel and a bottom panel associated with the multilayer display, such as a virtual cutout generated through pattern masking as further described herein. Various implementations configure virtual cutouts 1128 to allow access to interactive components 1130.

The audio system 1120 and/or the display system 1122 may include any devices that process, display, and/or otherwise render audio, video, display, and/or image data. Display data and audio signals can be communicated to an audio component and/or to a display component via an RF link, S-video link, HDMI (high-definition multimedia interface), composite video link, component video link, DVI (digital video interface), analog audio connection, or other similar communication link, such as media data port 1132. In implementations, the audio system and/or the display system are integrated components of the example device. Alternatively, the audio system and/or the display system are external, peripheral components to the example device.

Device 1100 also includes interactive components 1130 that provide a user with an interactive experience using device 1100. This can include a dual camera, a fingerprint scanner, a tactile feedback device, and so forth. Various implementations physical locate and/or expose interactive components 1130 in visible regions corresponding to virtual cutouts 1128 as further described herein.

### CONCLUSION

Various embodiments provide a virtual cutout in a dual panel display. Aspects of the dual panel display include at least one active partition between the dual panels, where the active partition includes electronic display circuitry disposed on a substrate. When activated, the active partition can be used to render content. Alternately or additionally, the dual panel display includes a virtual cutout with structure that creates a virtual cutout in the dual panel display. Various implementations interpose the virtual cutout between the dual panels of the dual panel display, where the virtual cutout is devoid of electronic display circuitry and provides visibility through the dual panel display. Some implementations physically locate interactive components in regions associated with the virtual cutout to enable access to the interactive components without using a physical cutout.

Although various implementations of virtual cutouts using pattern masking have been described in language specific to features and/or methods, the subject of the appended claims is not necessarily limited to the specific features or methods described. Rather, the specific features and methods are disclosed as example implementations, and other equivalent features and methods are intended to be within the scope of the appended claims. Further, various different embodiments are described and it is to be appreciated that each described embodiment can be implemented independently or in connection with one or more other described embodiments.

1. A display device for a mobile communication device comprising:
a display comprising a top panel, a bottom panel, and electronic display circuitry disposed on a substrate and interposed between the top panel and the bottom panel;
wherein the electronic display circuitry, when activated, enables the display device to render content on the display; and
wherein the substrate includes a virtual cutout region that is positioned between the top panel and the bottom panel, the virtual cutout region devoid of electronic display circuitry and configured to enable access to functionality other than content-rendering display functionality.

2. The display device as recited in claim 1, wherein the virtual cutout region comprises a generally trapezoidal shape.

3. The display device as recited in claim 1, wherein the electronic display circuitry surrounds at least three sides of the virtual cutout region.

4. The display device as recited in claim 1, wherein the display comprises a Liquid Crystal Display (LCD).

5. The display device as recited in claim 1, wherein the virtual cutout region visibly extends through the top panel and the bottom panel to enable visibility through the display.

6. The display device as recited in claim 1, wherein the display further comprises an aperture through the display in the virtual cutout region.

7. The display device as recited in claim 1, wherein the display further comprises a seal around a perimeter of the virtual cutout region and interposed between the top panel and the bottom panel.

8. (canceled)

9. (canceled)

10. (canceled)

11. (canceled)

12. (canceled)

13. (canceled)

14. A mobile communication device comprising:
one or more interactive components; and
a display comprising a top panel, a bottom panel, and electronic display circuitry disposed on a substrate and interposed between the top panel and the bottom panel;
wherein the electronic display circuitry, when activated, enables the display device to render content on the display; and
wherein the substrate includes a virtual cutout region that is positioned between the top panel and the bottom panel, the virtual cutout region devoid of electronic display circuitry and configured to enable access to the one or more interactive components.

15. The mobile communication device of claim 14, wherein the one or more interactive components comprises a scanner.

16. The mobile communication device of claim 14, wherein the one or more interactive components are physically located in a region of the mobile communication device associated with the virtual cutout region.

17. The mobile communication device of claim 16, wherein at least one of the one or more interactive components comprises an audio output module.

18. The mobile communication device of claim 17, wherein the display comprises an aperture in the virtual cutout region that allows access to the audio output module.

19. The mobile communication device of claim 14, wherein the at least one or more interactive components comprises a camera lens, and wherein the camera lens is physically located in a region associated with the virtual cutout region to provide the camera lens with visibility through the display.

20. The mobile communication device of claim 14, wherein the electronic display circuitry surrounds the virtual cutout region on all sides of the virtual cutout region.

21. A method for forming a display device for a mobile communication device comprising:
providing a top panel and a bottom panel;
providing electronic display circuitry disposed on a substrate;
interposing the electronic display circuitry between the top panel and the bottom panel to form a display of the display device;
wherein the electronic display circuitry, when activated, enables the display device to render content on the display; and
wherein the substrate includes a virtual cutout region that is positioned between the top panel and the bottom panel, the virtual cutout region devoid of electronic display circuitry and configured to enable access to functionality other than content-rendering display functionality.

22. The method as recited in claim 21, wherein the virtual cutout region comprises a generally trapezoidal shape.

23. The method as recited in claim 21, wherein the electronic display circuitry surrounds at least three sides of the virtual cutout region.

24. The method as recited in claim 21, wherein the display comprises a Liquid Crystal Display (LCD).

25. The method as recited in claim 21, wherein the virtual cutout region visibly extends through the top panel and the bottom panel to enable visibility through the display.

26. The method as recited in claim 21, wherein the display further comprises an aperture through the display in the virtual cutout region.
